(19) United States
(12) Patent Application Publication
(10) Pub. No.: US 2013/0326105 A1
(43) Pub. Date: Dec. 5, 2013

(54) PROCESSOR WITH REAL-TIME SIGNAL TRANSMISSION AND STORAGE

(71) Applicant: Wen-Chuan Yang, Changhua (TW)

(72) Inventor: Wen-Chuan Yang, Changhua (TW)

(21) Appl. No.: 13/489,378

(22) Filed: Jun. 5, 2012

(51) Int. Cl. G06F 13/36

(52) U.S. Cl. 710/305

(57) ABSTRACT

A processor with real-time signal transmission and storage comprises a motherboard and a display. The motherboard has a power input end, a processing core, a signal input end, a storage device and an image output end. The power input end has one conducting wire to connect to the power source to provide power to the motherboard and a display; the processing core has a processing program inside and connect to the signal input end and the storage device; the signal input end provides a transmission line to connect an input end of a working unit; and the storage device provides space to save signals complied and organized by the processing core. The display has a signal connector to connect to the image output end of the motherboard.

### FIELD OF THE INVENTION

The present invention relates to a processor, and more particularly to a processor with real-time signal transmission and storage, so the signal can be transmitted, compiled and written into a storage device to store, which forms a paperless storing style to reduce the usage of paper and increase the convenience of data storage

### BACKGROUND OF THE INVENTION

Conventionally, after a working unit is started, if a user wants to save or store the data generated by the working unit, the user usually directly connects the working unit to the printer through a connecting cable, so the data can be output from the printer, and then file the data according to time, product number or serial number of the working unit. However, the data have to be saved when the working unit is in operation, which generates more and more paper to occupy space and cause inconvenience for storage. Moreover, when the user wants to search the archived data, it is inconvenient for the user to search voluminous paper. Also, in order to solve abovementioned problems, a computer may be equipped to connect with the working unit to directly transmit and save the data to the computer, so the data can be archived in the computer and it is convenient for the user to search. However, the entire setup with the computer may be too bulky and it may not be appropriate in the working environment to connect the working unit to the computer. In addition, it may not be cost-effective to set up the computer. Therefore, there remains a need for a new and improved processor to overcome the problems stated above.

### SUMMARY OF THE INVENTION

The problem the present invention would like to solve is (i) after a conventional working unit is started, if a user wants to save or store the data generated by the working unit, the user usually directly connects the working unit to the printer through a connecting cable, so the data can be output from the printer, and then file the data according to time, product number or serial number of the working unit. However, the data have to be saved when the working unit is in operation, which generates more and more paper to occupy space and cause inconvenience for storage. Moreover, when the user wants to search the archived data, it is inconvenient for the user to search voluminous papers; and (ii) when a computer is equipped to connect with the working unit to directly transmit and save the data to the computer, the data can be archived in the computer and it is convenient for the user to search. However, the entire setup with the computer may be too bulky and it may not be appropriate in the working environment to connect the working unit to the computer. In addition, it may not be cost-effective to set up the computer.

To solve and overcome the problems stated above, the present invention provides a processor with real-time signal transmission and storage includes a motherboard and a display. The motherboard has a power input end, a processing core, a signal input end, a storage device and an image output end. The power input end has one conducting wire to connect to the power source to provide power to the motherboard and the display. The processing core has a processing program inside and connect to the signal input end and the storage device. The signal input end provides a transmission line to connect an input end of a working unit, and when the working unit starts to operate and generate data, the data can be transmitted from the signal input end to the processing core to compile. The storage device provides space to save signals complied and organized by the processing core, and the storage device can be an expansion slot for memory cards. The display has a signal connector to connect to the image output end of the motherboard, and a processor with real-time signal transmission and storage function is thus formed.

Comparing with the conventional arts, the present invention is advantageous because (i) the signal input end in the present invention is directly connected with the working unit that can output the signal, so when data are generated by the working unit, the data can be transmitted into the motherboard through the signal input end, compiled by the processing core and written into the storage device to store the data and information, which forms a paperless storing style to reduce the usage of paper and increase the convenience of data storage; and (ii) the size of the processor is small, and can be directly connected with the working unit that can output signals, so that the processor is not restricted by the environment and can effectively replace computers to save the information and data with less costs.

### BRIEF DESCRIPTION OF THE DRAWINGS

FIG. 1 illustrates a three-dimensional view in the present invention.

FIG. 2 illustrates a block diagram in the present invention.

FIG. 3 illustrates a block diagram when the processor is in use.

FIG. 4 illustrates a schematic view of the display in the present invention.

FIG. 5 illustrates another embodiment in the present invention.

FIG. 6 illustrates a different embodiment in the present invention.

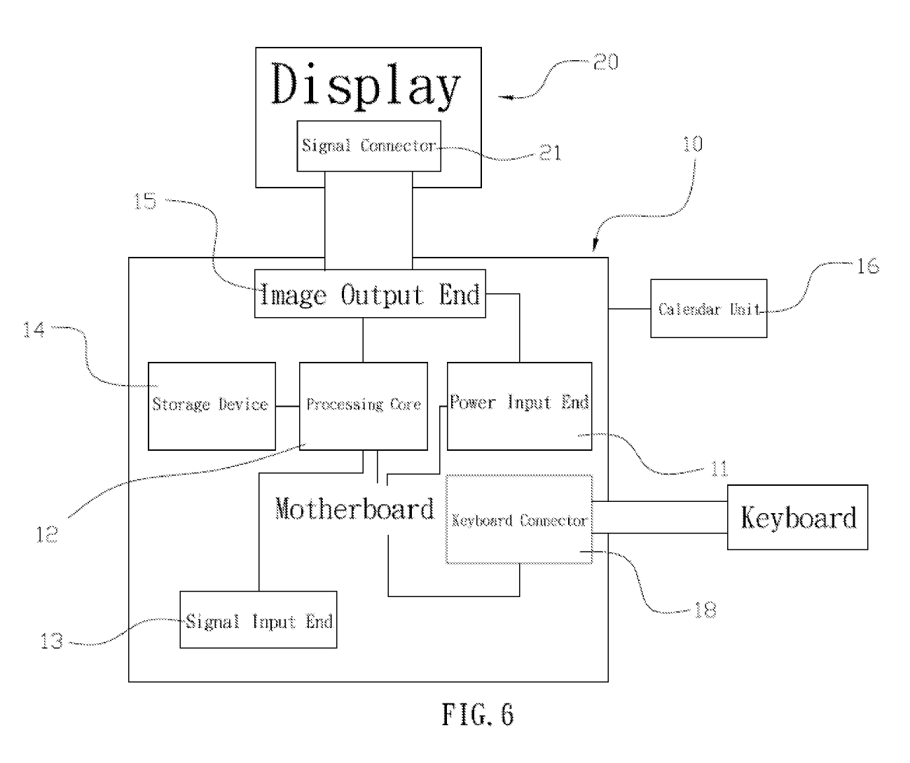

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

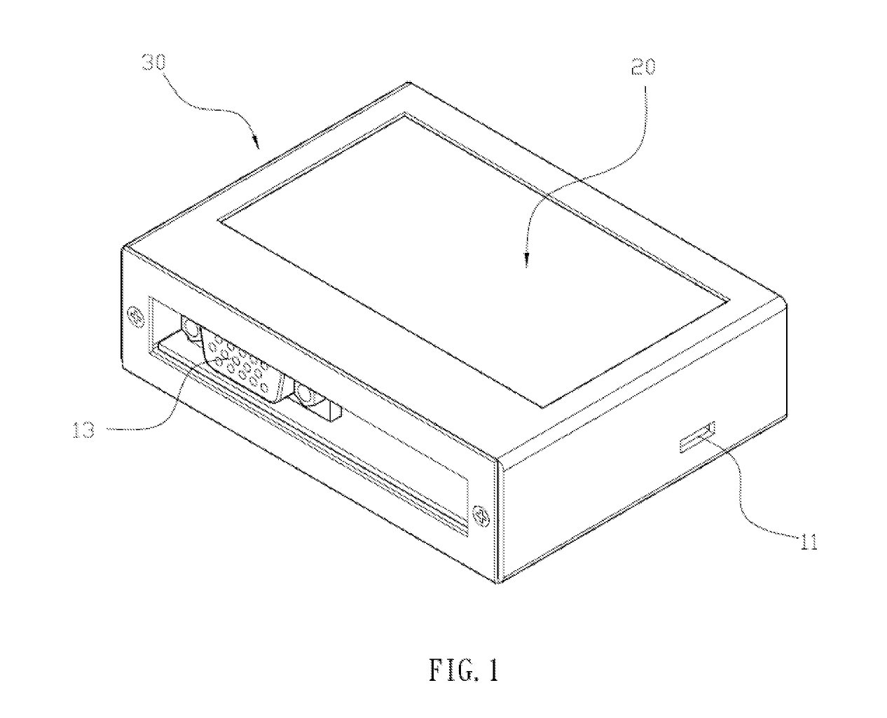

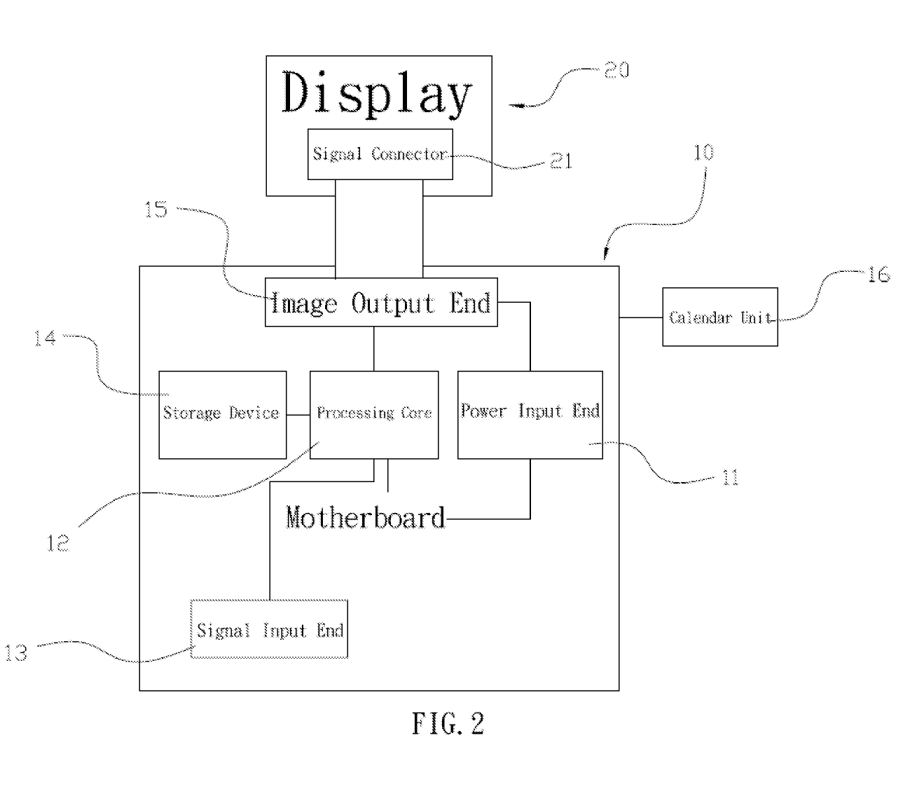

Referring to FIGS. 1 to 2, a processor with real-time signal transmission and storage includes a motherboard (10), a display (20) and a main body (30). The motherboard (10) has a power input end (11), a processing core (12), a signal input end (13), a storage device (14) and an image output end (15). The power input end (11) has one conducting wire to connect to the power source to provide power to the motherboard (10) and the display (20). The power input end (11) can be a USB universal serial bus to connect to the computer to provide power or transmit data. The processing core (12) has a processing program inside and connect to the signal input end (13) and the storage device (14). The signal input end (13) provides a transmission line to connect an input end of a working unit, and the signal input end (13) can be a digital signal transmission port such as RS-232, RS-422 and RS-485, an analog signal connector (4˜20 mA or DC 0˜10V), or USB universal serial bus. The storage device (14) provides spaces to save signals complied and organized by the processing core (12), and the storage device (14) can be an expansion slot for memory cards. The motherboard also has a calendar unit (16) that has an independent power source to maintain the operation. The display (20) has a signal connector (21) to connect to the image output end (15) of the motherboard (10). The main body (30) is circularly disposed outside the motherboard (10) and the display (20) to achieve the goal of protection.

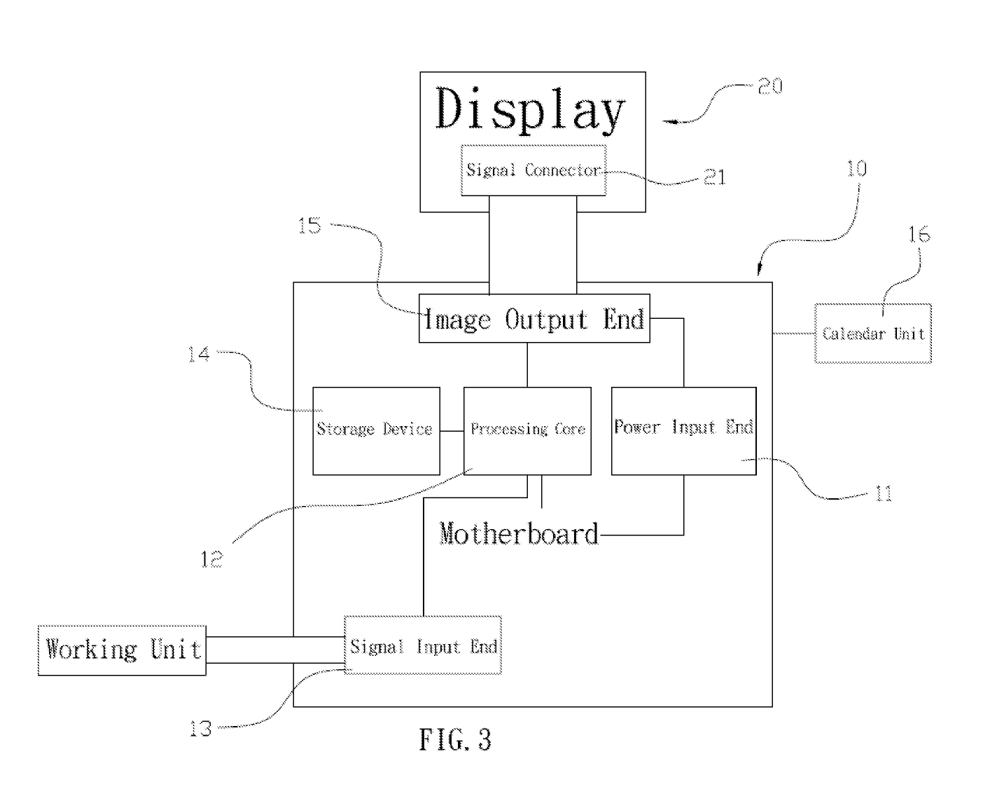

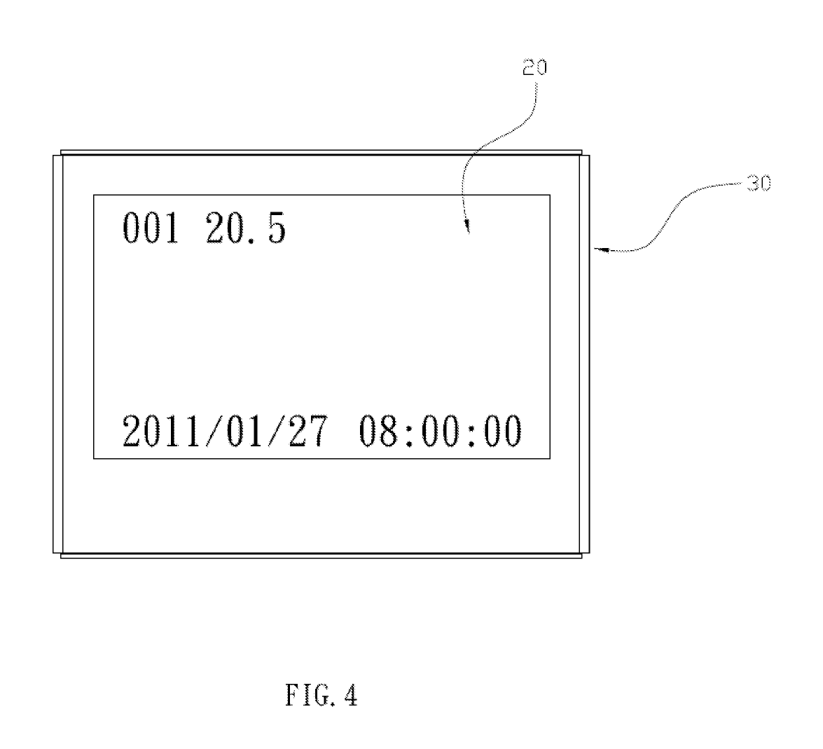

Referring to FIGS. 3 and 4 for the structure and practical usage of the present invention, the display (20) is connected to the image output end (15) of the motherboard (10) through the signal connector (21), and connected to the power source through the power input end (11) to obtain power for the motherboard (10) and the display (20). The signal input end (13) of the motherboard (10) is connected to the working unit, and when the working unit starts the operation to input data, the data will enter the processing core (12) inside the motherboard (10) from the signal input end (13). The data can be displayed and viewed on the display (20) after being compiled and written into the memory card of the storage device (14) to complete the process of data transmission and storage. The memory card inserted into the storage device (14) can be read when inserted into computers to be further edited or compiled. The motherboard (10) has the calendar unit (16) to enhance the convenience of filing and storing the information or data from the working unit.

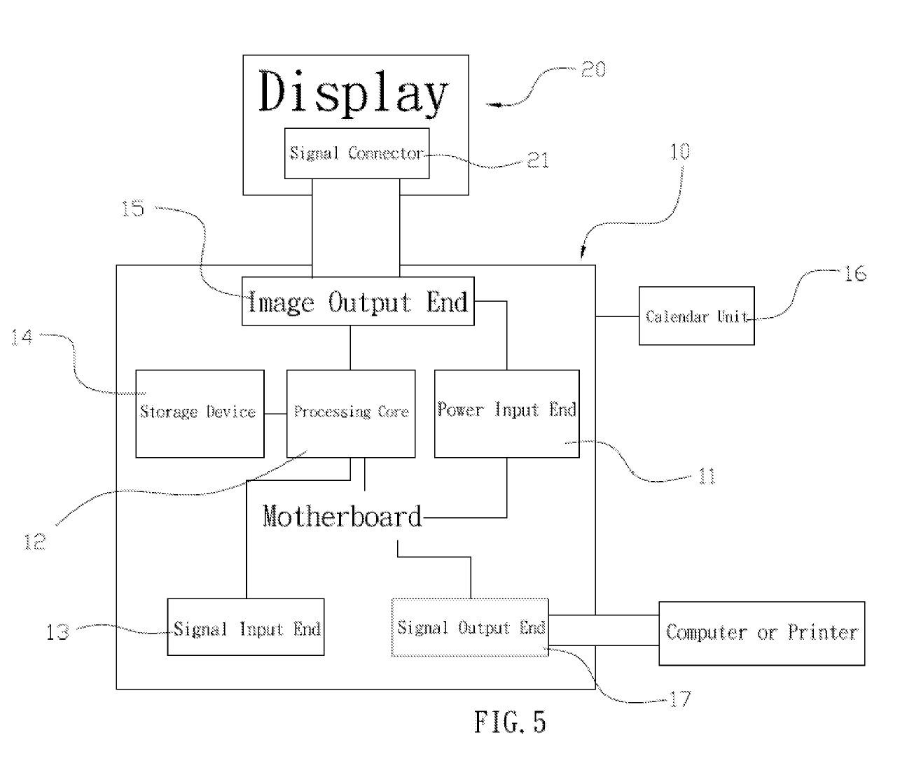

The motherboard (10) also has a signal output end (17) to connect with computers or printers to save the information or data in the storage device (14) to the computer, or print out the information compiled by the processing core (12) from the printer in real-time, as can be seen in FIG. 5.

Moreover, the motherboard (10) has a keyboard connector (18) to connect with a keyboard to view and edit the data or information in the storage device (14) from the keyboard to enhance the convenience of using the processor.

According to the embodiments discussed above, the present invention is advantageous because (i) the signal input end (13) in the present invention is directly connected with the working unit that can output the signal, so when data are generated by the working unit, the data can be transmitted into the motherboard (10) through the signal input end (13), compiled by the processing core (12) and written into the storage device (14) to store the data and information, which forms a paperless storing style to reduce the usage of paper and increase the convenience of data storage; and (ii) the size of the processor is small, and can be directly connected with the working unit that can output signals, so that the processor is not restricted by the environment and can effectively replace computers to save the information and data with less costs.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A processor with real-time signal transmission and storage comprising:
a motherboard having a power input end, a processing core, a signal input end, a storage device and an image output end, wherein the power input end has one conducting wire to connect to the power source to provide power to the motherboard and a display; the processing core has a processing program inside and connect to the signal input end and the storage device; the signal input end provides a transmission line to connect an input end of a working unit, and when the working unit starts to operate and generate data, the data are transmitted from the signal input end to the processing core to compile; and the storage device provides space to save signals complied and organized by the processing core, and
a display having a signal connector to connect to the image output end of the motherboard.

2. The processor with real-time signal transmission and storage of claim 1, wherein the power input end is a USB universal serial bus to connect to a computer to provide power or transmit data.

3. The processor with real-time signal transmission and storage of claim 1, wherein the signal input end is a digital signal transmission port such as RS-232, RS-422 and RS-485.

4. The processor with real-time signal transmission and storage of claim 1, wherein the signal input end is an analog signal connector (4˜20 mA or DC 0˜10V).

5. The processor with real-time signal transmission and storage of claim 1, wherein the signal input end is a USB universal serial bus.

6. The processor with real-time signal transmission and storage of claim 1, wherein the motherboard has a calendar unit that has an independent power source to maintain its operation.

7. The processor with real-time signal transmission and storage of claim 1, wherein a main body is circularly disposed outside the motherboard and the display to protect the motherboard and the display.

8. The processor with real-time signal transmission and storage of claim 1, wherein the motherboard has a signal output end to connect with computers or printers to save information or data in the storage device into to the computer, or print out the information compiled by the processing core from the printer in real-time.

9. The processor with real-time signal transmission and storage of claim 1, wherein the motherboard has a keyboard connector to connect with a keyboard to view and edit data or information in the storage device.

10. The processor with real-time signal transmission and storage of claim 1, wherein the storage device is an expansion slot for memory cards.
